(19) United States
(12) Patent Application Publication
(10) Pub. No.: US 2026/0259010 A1
(43) Pub. Date: Sep. 3, 2026

(54) HEAT EXCHANGER

(71) Applicant: Komatsu Ltd., Tokyo (JP)

(72) Inventor: Koki Hirasawa, Tokyo (JP)

(73) Assignee: Komatsu Ltd., Tokyo (JP)

(21) Appl. No.: 18/871,643

(22) PCT Filed: Aug. 3, 2023
(86) PCT No.: PCT/JP2023/028408

§ 371 Date: Dec. 4, 2024

(30) Foreign Application Priority Data
Sep. 5, 2022 (JP) 2022-140677

(51) Int. Cl. F28D 7/16; F28D 21/00; F28F 13/12

(52) U.S. Cl. CPC F28D 7/1607; F28D 21/0003; F28F 13/12

(57) ABSTRACT

This heat exchanger includes a tube that has an inner surface facing an internal passage through which an exhaust gas discharged from an engine is able to flow and an outer surface facing an external passage through which cooling water for heat exchange with the exhaust gas is able to flow, and extends in a flow direction of the exhaust gas, and a riblet structure that is provided on the inner surface of the tube and has a plurality of convex portions extending in an extension direction of the tube, in which the riblet structure has a bottom wall surface that is aligned with the inner surface of the tube at a bottom between two adjacent convex portions among the plurality of convex portions.

### TECHNICAL FIELD

The present invention relates to a heat exchanger.

Priority is claimed on Japanese Patent Application No. 2022-140677, filed Sep. 5, 2022, the content of which is incorporated herein by reference.

### BACKGROUND ART

Conventionally, there is known an EGR (Exhaust Gas Recirculation) system that reduces the amount of NOx (nitrogen oxides), that is a regulated substance, by returning a part of an exhaust gas discharged from an engine to an intake air and lowering a combustion temperature.

For example, Patent Document 1 discloses an EGR cooler that cools the EGR gas when a part of the exhaust gas from an engine is recirculated to the engine by flowing it into an intake passage as an exhaust recirculation (EGR) gas. This EGR cooler is equipped with a heat exchanger that has a water passage through which cooling water flows and a gas passage disposed in the water passage through which the EGR gas flows.

In recent years, further reductions in NOx have been considered in environmental regulations. To further reduce NOx, it is necessary to lower the combustion temperature. To achieve this, it is necessary to lower an oxygen concentration in the intake air, and increasing the amount of the EGR gas and lowering its temperature (improve performance) become issues. For example, it may be possible to change the size of the heat exchanger (for example, make it larger) to improve performance.

### RELATED ART DOCUMENT

### Patent Document

Patent Document 1: Japanese Unexamined Patent Application, First Publication No. 2020-84890

### SUMMARY

### Problems to be Solved by the Invention

However, if a size of the heat exchanger is changed, it is highly likely there will be a need to change a layout of the peripheral parts, such as pipes connected to the heat exchanger. For this reason, there is room for improvement in terms of improving performance without changing the size.

Therefore, an object of the present invention is to provide a heat exchanger that can reduce a pressure loss in an internal passage through which an exhaust gas flows and improve a heat exchange efficiency without changing the size.

### Solution to Problem

A heat exchanger according to one aspect of the present invention includes a tube that has an inner surface facing an internal passage through which an exhaust gas discharged from an engine is able to flow and an outer surface facing an external passage through which cooling water for heat exchange with the exhaust gas is able to flow, and extends in a flow direction of the exhaust gas, and a riblet structure that is provided on the inner surface of the tube and has a plurality of convex portions extending in an extension direction of the tube, in which the riblet structure has a bottom wall surface that is aligned with the inner surface of the tube at a bottom between two adjacent convex portions among the plurality of convex portions.

### Advantage of the Invention

According to the aspects described above, it is possible to reduce a pressure loss in an internal passage through which an exhaust gas flows and improve a heat exchange efficiency without changing the size.

### BRIEF DESCRIPTION OF DRAWINGS

FIG. 1 A diagram that describes an overall configuration of an engine system according to an embodiment.

FIG. 2 A cross-sectional view of an EGR cooler of the embodiment, taken along a flow direction of an exhaust gas.

FIG. 3 A cross-sectional view, taken along line III-III in FIG. 2.

FIG. 4 A perspective view of a portion of a heat exchanger according to the embodiment.

FIG. 5 A perspective view of a riblet structure according to the embodiment.

FIG. 6 A cross-sectional view of the riblet structure according to the embodiment.

FIG. 7 A diagram that describes an operation of the riblet structure of the embodiment.

FIG. 8 A perspective view of a riblet structure according to a comparative example.

FIG. 9 A diagram that describes an operation of the riblet structure according to the comparative example.

FIG. 10 A cross-sectional view of a riblet structure according to a first modified example of the embodiment.

FIG. 11 A cross-sectional view of a riblet structure according to a second modified example of the embodiment.

FIG. 12 A cross-sectional view of a riblet structure according to a third modified example of the embodiment.

FIG. 13 A cross-sectional view of a riblet structure according to a fourth modified example of the embodiment.

### DESCRIPTION OF EMBODIMENTS

Hereinafter, an embodiment of the present invention will be described with reference to the drawings. In the embodiment, as an example of a heat exchanger, an example of a heat exchanger for an EGR cooler that cools an EGR gas when a part of an exhaust gas discharged from an engine is recirculated to the engine as an EGR gas will be described.

### <Engine System>

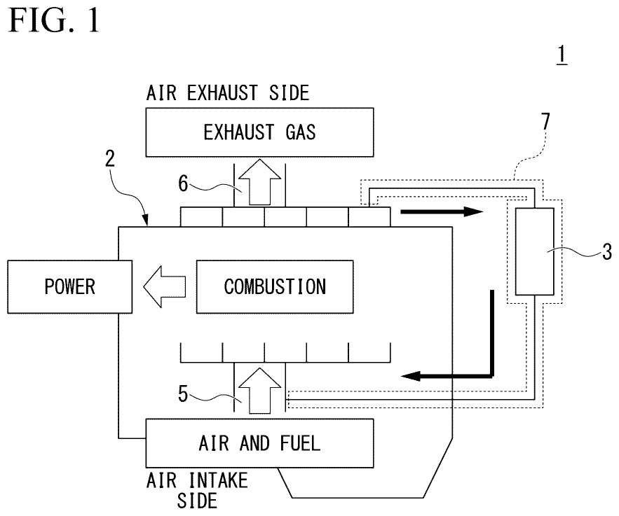

FIG. 1 is an overall configuration diagram of an engine system according to an embodiment.

For example, the engine system 1 is installed in construction machinery, transport vehicles, various industrial machines, and the like. The engine system 1 includes an engine 2 and an EGR cooler 3.

Although not shown, the engine 2 includes a piston, a crankshaft, and the like. An intake gas (for example, a combustible gas mixture containing air and fuel) is introduced into the engine 2 through an intake passage 5. The combustible gas mixture introduced into the engine 2 explodes and burns when it is ignited by an ignition device. The gas after combustion is discharged through an exhaust passage 6 as an exhaust gas. At this time, the piston moves up and down and the crankshaft rotates. This provides power to the engine 2.

### <EGR Cooler>

The EGR cooler 3 is provided in an EGR passage 7 (shown by a dashed line in FIG. 1). The EGR cooler 3 cools an EGR gas (a part of the exhaust gas) flowing through the EGR passage 7. An inlet of the EGR passage 7 is connected to the exhaust passage 6. An outlet of the EGR passage 7 is connected to the intake passage 5.

A part of the exhaust gas discharged from the engine 2 is introduced as EGR gas into the EGR cooler 3 through the inlet of the EGR passage 7. The EGR gas cooled by the EGR cooler 3 is introduced into the intake passage 5 through the outlet of the EGR passage 7. In this manner, a part of the exhaust gas discharged from the engine 2 is recirculated to the engine 2 as an EGR gas.

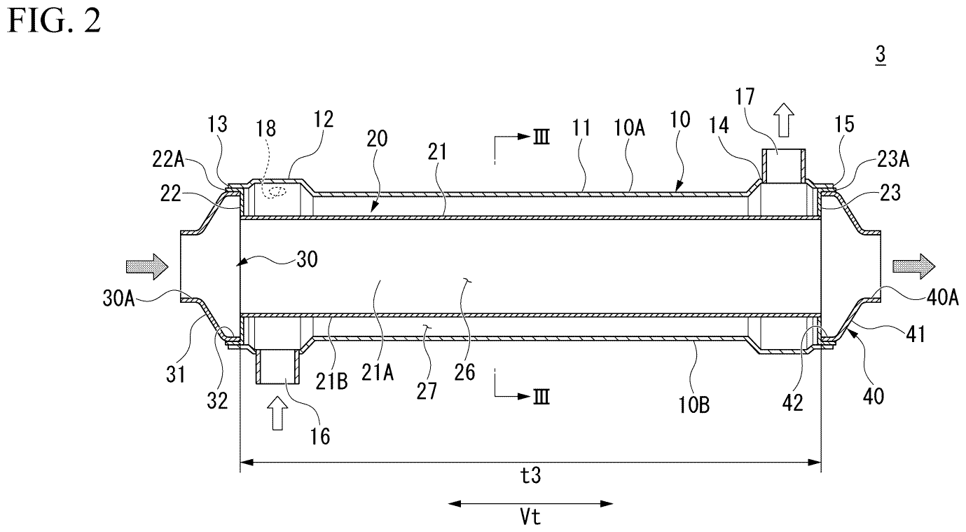

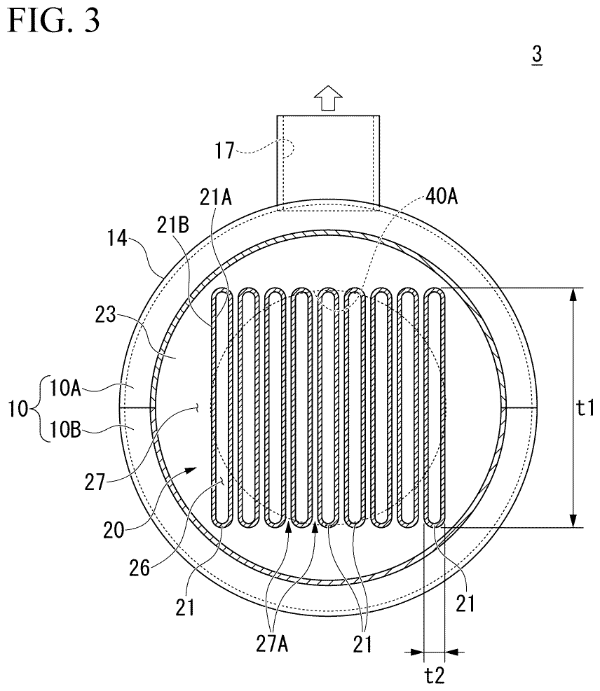

FIG. 2 is a cross-sectional view of the EGR cooler 3 according to the embodiment, taken along a flow direction of the exhaust gas (an EGR gas). FIG. 3 is a cross-sectional view, taken along line III-III in FIG. 2. In the following description, an upstream side in a flow direction of the exhaust gas is referred to as a “front side,” and a downstream side in the flow direction of the exhaust gas is referred to as a “rear side.” In addition, left and right refer to left and right as viewed from the front side.

The EGR cooler 3 includes a cylindrical case 10, a heat exchanger 20 housed inside the case 10, an inlet tank 30 joined to the front side of the case 10, and an outlet tank 40 joined to the rear side of the case 10.

The case 10 includes a body portion 11 forming a front-to-rear center of the case 10, a front bulging portion 12 that bulges outward from a front end of the case 10 to have a larger diameter than the body portion 11, a front opening end 13 that forms a front end opening of the case 10, a rear bulging portion 14 that bulges outward from a rear end of the case 10 to have a larger diameter than the body portion 11, and a rear opening end 15 that forms a rear end opening of the case 10.

An inflow port 16 is formed at a lower part of the front bulging portion 12, which allows cooling water to flow into the case 10.

An outflow port 17 is formed at a top of the rear bulging portion 14, which allows cooling water that has flowed into the case 10 to flow out. A gas exhaust hole 18 for exhausting a gas from the case 10 may be formed at a top of the front bulging portion 12. Although one gas exhaust hole 18 is shown in FIG. 2, the number is not limited and can be changed according to the design specifications.

The case 10 has a first case body 10A and a second case body 10B that are split in half in a vertical direction. For example, the first case body 10A and the second case body 10B are joined to each other by welding or the like. The case 10 may also have a split structure in a horizontal direction. For example, a form of the split structure of the case 10 can be changed according to the design specifications.

The heat exchanger 20 includes a plurality of tubes 21 extending in the flow direction of the exhaust gas, a front header plate 22 joined to a front end of each tube 21, and a rear header plate 23 joined to a rear end of each tube 21. The tubes 21 have a flat shape extending vertically when viewed from the front. The plurality of tubes 21 (9 tubes are shown in FIG. 3) are lined up horizontally when viewed from the front. The number of tubes 21 is not limited and can be changed according to the design specifications.

When viewed from the front, a distance t1 between upper and lower ends of the tube 21 is a “vertical length t1 of the tube 21,” and a distance t2 between left and right sides of the tube 21 is a “horizontal width t2 of the tube 21.” For example, the vertical length t1 of the tube 21 is 50 mm or more and 150 mm or less. For example, the horizontal width t2 of the tube 21 is 5 mm or more and 15 mm or less. The vertical length t1 of the tube 21 and the horizontal width t2 of the tube 21 are not limited to the description above and can be changed according to the design specifications.

For example, parts of surfaces of each tube 21 that face each other are brazed to each other at dot-shaped protruding portions. For example, the front header plate 22 is brazed to the front end of each tube 21. For example, the rear header plate 23 is brazed to the rear end of each tube 21.

A gap between the surfaces of each tube 21 that face each other when the tubes are lined up horizontally as viewed from the front side forms a cooling water flow path 27A (a part of the external passage 27) through which cooling water passes. It is preferable that all cooling water flow paths 27A are set to the same width dimension. In the present embodiment, the tubes 21 are lined up horizontally, and the inflow port 16 for the cooling water is formed at the lower part of the front bulging portion 12. For this reason, the cooling water from the inflow port 16 immediately flows into the cooling water flow path 27A.

The inflow port 16 for the cooling water is preferably formed at a left-to-right center of the lower part of the front bulging portion 12. As a result, the flow direction of the cooling water immediately after it flows in from the inflow port 16 is the same as the vertical direction of each tube 21, so that a flow of the cooling water is prevented from being obstructed.

A front cylindrical portion 22A is formed on an outer periphery of the front header plate 22, which is aligned with an inner periphery of the front opening end 13 of the case 10. A front end of the front cylindrical portion 22A is disposed on a further front side than the front opening end 13 of the case 10.

A rear cylindrical portion 23A is formed on an outer periphery of the rear header plate 23, which is aligned with an inner periphery of the rear opening end 15 of the case 10. A rear end of the rear cylindrical portion 23A is disposed on a further rear side than the rear opening end 15 of the case 10.

The inlet tank 30 is joined to the front end of the case 10 via the front header plate 22. The inlet tank 30 includes a front peripheral wall portion 31 that expands in diameter and extends to the rear side from the exhaust inlet 30A, which is an inflow port for the exhaust gas, and a front opening wall portion 32 that is formed on the rear end of the front peripheral wall portion 31 and is aligned with an inner periphery of the front cylindrical portion 22A.

The outlet tank 40 is joined to the rear end of the case 10 via the rear header plate 23. The outlet tank 40 includes a rear peripheral wall portion 41 that expands in diameter and extends to the front side from the exhaust outlet 40A, which is an outflow port for the exhaust gas, and a rear opening wall portion 42 that is formed on a front end of the rear peripheral wall portion 41 and is aligned with an inner periphery of the rear cylindrical portion 23A.

For example, it is preferable to assemble the EGR cooler 3 in the following manner.

First, the tubes 21 are brazed together. Then, the header plates 22 and 23 are brazed to a brazed structure (a joint of the plurality of tubes 21). In this manner, the heat exchanger 20 is prefabricated.

Then, the heat exchanger 20 is housed inside the case 10, which is made up of case bodies 10A and 10B in a split structure. Then, the case bodies 10A and 10B are joined to each other by welding or the like. Then, tanks 30 and 40 are joined to each end of the case 10 via the header plates 22 and 23 by welding or the like. At this time, cylindrical portions 22A and 23A of the header plates 22 and 23 are fitted inside opening ends 13 and 15 of the case 10. In addition, opening wall portions 32 and 42 of the tanks and 40 are fitted further inside the cylindrical portions 22A and 23A. In this state, they are joined to each other by welding.

### <Heat Exchanger>

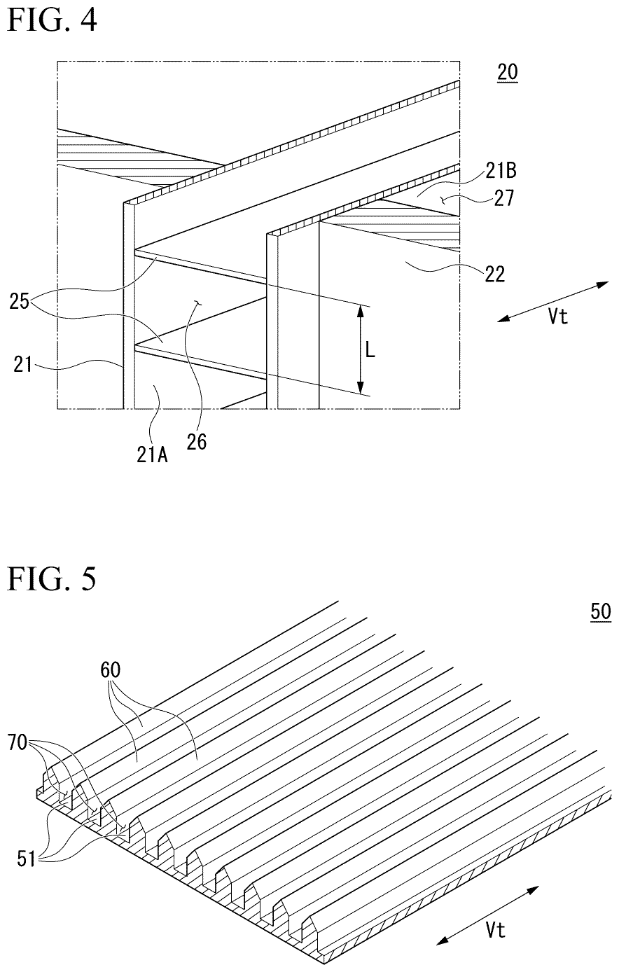

FIG. 4 is a perspective view of a portion of the heat exchanger 20 according to the embodiment. FIG. 5 is a perspective view of the riblet structure 50 according to the embodiment.

The heat exchanger 20 includes the tube 21, the header plates 22 and 23 (a front header plate 22 is shown in FIG. 4), a fin 25, and the riblet structure 50. FIG. 4 shows a peripheral structure of one of the plurality of tubes 21. Note that the riblet structure 50 is omitted to be shown in FIG. 4.

The tube 21 has an inner surface 21A facing an internal passage 26 through which the exhaust gas discharged from the engine 2 can flow, and an outer surface 21B facing an external passage 27 through which cooling water for heat exchange with the exhaust gas can flow. The tube 21 extends in the flow direction of the exhaust gas. Hereinafter, a direction Vt in which the tube 21 extends in the flow direction of the exhaust gas is referred to as an “extension direction Vt of the tube 21.”

A length t3 of the tube 21 in the extension direction Vt (a distance between the front end and the rear end of the tube 21) is referred to as an “extension length t3 of the tube 21” (refer to FIG. 2). For example, the extension length t3 of the tube 21 is 200 mm or more and 400 mm or less. The extension length t3 of the tube 21 is not limited to the description above and can be changed according to the design specifications.

The fin 25 is provided in the internal passage 26 of the tube 21. The fin 25 extends in the extension direction Vt of the tube 21. The fin 25 is formed in a plate shape with a length in the flow direction of the exhaust gas and a thickness in the vertical direction when viewed from the front. A plurality of fins 25 are lined up at a distance in the vertical direction when viewed from the front. FIG. 4 shows two fins 25 that face each other in the vertical direction among the plurality of fins 25.

### <Riblet Structure>

The riblet structure 50 is provided on the inner surface 21A and outer surface 21B of the tube 21 and on a surface of the fin 25 (for example, both upper and lower surfaces of the fin 25 shown in FIG. 4). As shown in FIG. 5, the riblet structure 50 has a plurality of convex portions 60 extending in the extension direction Vt of the tube 21. For example, methods for processing the riblet structure 50 include etching, sputtering, pressing, and the like, as well as a method of vacuum laminating a thin plate (for example, a plate material having a thickness of about 50 μm) onto a plate material.

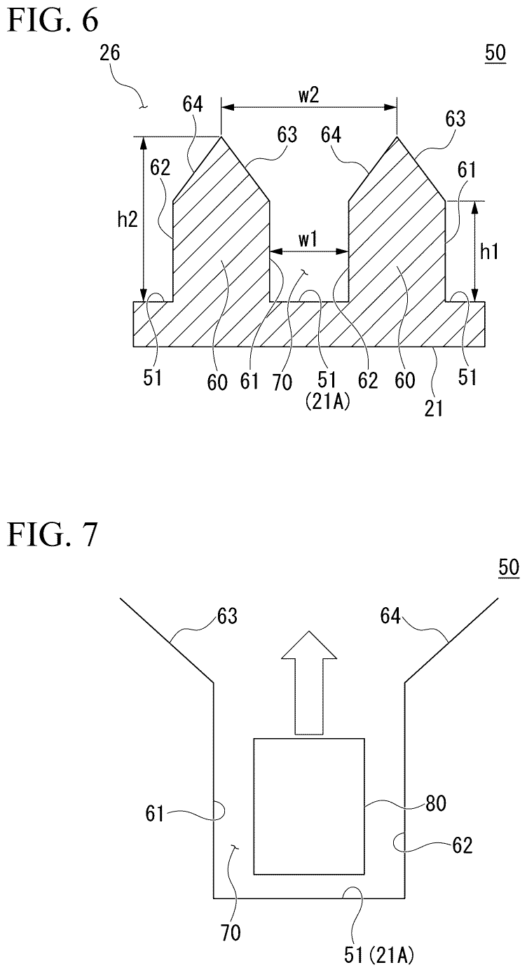

FIG. 6 is a cross-sectional view of the riblet structure 50 according to the embodiment. FIG. 6 is a cross-sectional view orthogonal to the extension direction Vt of the tube 21. In the cross-sectional view of FIG. 6, an enlarged view of a part of a portion of the heat exchanger 20 where the riblet structure 50 is provided (for example, a portion on the inner surface 21A side of the tube 21) is shown.

The riblet structure 50 has a bottom wall surface 51 that is aligned with the inner surface 21A of the tube 21 at a bottom (a lower part in FIG. 6) between two adjacent convex portions 60 among the plurality of convex portions 60.

The convex portions 60 are continuous and of uniform size in the extension direction Vt of the tube 21. For example, the sizes (cross-sectional areas) of the convex portions 60 are the same at any cross-sectional position orthogonal to the extension direction Vt of the tube 21.

The riblet structure 50 has an opening 70 between two adjacent convex portions 60 in the plurality of convex portions 60. The opening 70 is a groove that is continuous and of uniform size in the extension direction Vt of the tube 21. For example, the size (opening area) of the opening 70 is the same at any cross-sectional position orthogonal to the extension direction Vt of the tube 21.

The riblet structure 50 has a first side wall surface 61 and a second side wall surface 62 that face each other at two convex portions 60. In the cross-sectional view of FIG. 6, the bottom wall surface 51, the first side wall surface 61, and the second side wall surface 62 have shapes that are aligned with three sides of a rectangle (an example of a quadrangle).

In the cross-sectional view of FIG. 6, the first side wall surface 61 and the second side wall surface 62 extend perpendicularly from the bottom wall surface 51. In the cross-sectional view of FIG. 6, the first side wall surface 61 and the second side wall surface 62 are parallel to each other. In the cross-sectional view of FIG. 6, the first side wall surface 61 and the second side wall surface 62 extend to the same height from the bottom wall surface 51.

In the cross-sectional view of FIG. 6, the riblet structure 50 further has inclined wall surfaces 63 and 64 that extend obliquely from ends (upper ends in FIG. 6) of the first side wall surface 61 and the second side wall surface 62 opposite to the bottom wall surface 51. In the cross-sectional view of FIG. 6, the inclined wall surfaces 63 and 64 gradually move away from each other as they move upward from upper ends of the side wall surfaces 61 and 62. Hereinafter, the inclined wall surface 63 extending obliquely from the end of the first side wall surface 61 opposite to the bottom wall surface 51 is referred to as a “first inclined wall surface 63,” and the inclined wall surface 64 extending obliquely from the end of the second side wall surface 62 opposite to the bottom wall surface 51 is referred to as a “second inclined wall surface 64.”

In the cross-sectional view of FIG. 6, when one convex portion 60 is focused on, the first inclined wall surface 63 and the second inclined wall surface 64 have shapes that are aligned with two hypotenuses of a triangle. In the cross-sectional view of FIG. 6, one convex portion 60 has a shape that combines a rectangle (a lower shape of the convex portion in FIG. 6) and a triangle (an upper shape of the convex portion in FIG. 6).

In the cross-sectional view of FIG. 6, a distance w1 between the first side wall surface 61 and the second side wall surface 62 among distances between two convex portions 60 (a width of the opening 70) is set to a “minimum opening width w1,” a distance w2 between an upper end of the first inclined wall surface 63 (an upper end of one convex portion 60) and an upper end of the second inclined wall surface 64 (an upper end of the other convex portion 60) is set to a “maximum opening width w2,” a distance h1 between the upper ends of the side wall surfaces 61 and 62 and the bottom wall surface 51 is set to a “side wall surface height h1,” and a distance h2 between an upper end of the convex portion 60 and the bottom wall surface 51 (a maximum vertical height of the convex portion 60) is set to a “maximum height h2.”

For example, the minimum opening width w1 and the side wall surface height h1 are 1 to 10H.

H refers to a Kolmogorov scale and is expressed by the following equation (1).

$$[ Math 1 ]$$

$$H = {R}^{- \frac{3}{4}} L \qquad ( 1 )$$

In Equation (1) described above, R is a Reynolds number and L is a characteristic length. The characteristic length L is a distance between two fins 25 that face each other in the vertical direction among the plurality of fins 25 (refer to FIG. 4). In FIG. 4, the characteristic length L is a distance between a lower surface of an upper fin and an upper surface of a lower fin 25 of the two fins 25.

For example, a maximum value of the Kolmogorov scale H is about 4.3 μm at an engine rated point of the EGR cooler 3 (a rated point where the most high-temperature EGR gas is present). For example, the minimum opening width w1 is 1 μm or more and 50 μm or less. For example, the side wall surface height h1 is 1 μm or more and 50 μm or less. For example, the minimum opening width w1 and the side wall surface height h1 are of the same size. Note that the minimum opening width w1 and the side wall surface height h1 may be of different sizes and can be changed according to the design specifications.

For example, the maximum opening width w2 and the maximum height h2 are to 30H.

For example, the maximum opening width w2 is 10 μm or more and 750 μm or less in size. For example, the maximum height h2 is 10 μm or more and 750 μm or less in size. For example, the maximum opening width w2 and the maximum height h2 are the same size. Note that the maximum opening width w2 and the maximum height h2 may be different sizes and can be changed according to the design specifications.

### <Operation of Riblet Structure>

FIG. 7 is a diagram that describes an operation of the riblet structure 50 according to the embodiment. FIG. 7 corresponds to an enlarged view of an opening between the two convex portions 60 in FIG. 6. A reference numeral 80 in FIG. 7 indicates a vortex tube that occurs in a turbulent flow.

In the present embodiment, the riblet structure 50 has a bottom wall surface 51 that is aligned with the inner surface 21A of the tube 21. For this reason, a vortex tube 80 grows in a vertical direction (upward in FIG. 7) intersecting with the bottom wall surface 51.

In the present embodiment, in the cross-sectional view orthogonal to the extension direction Vt of the tube 21, the bottom wall surface 51, the first side wall surface 61, and the second side wall surface 62 have shapes that are aligned with three sides of a rectangle. For this reason, the vortex tube 80 does not grow in a lateral direction (the horizontal direction in FIG. 7). In the present embodiment, a growth direction of the vortex tube 80 is restricted by the bottom wall surface 51, the first side wall surface 61, and the second side wall surface 62. For example, the growth direction of the vortex tube 80 is only upward in FIG. 7.

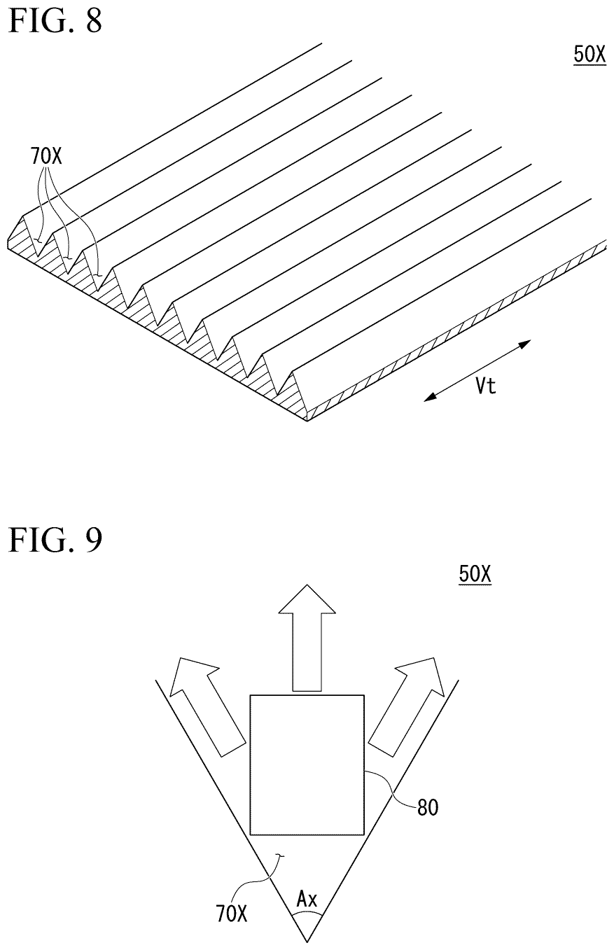

FIG. 8 is a perspective view of a riblet structure 50X according to a comparative example. FIG. 9 is a diagram that describes an operation of the riblet structure 50X according to the comparative example.

In the comparative example, in a cross-sectional view orthogonal to the extension direction Vt of the tube 21, there is a V-shaped (an inverted triangle) opening 70X. For this reason, the vortex tube 80 grows in a diagonal direction to the left and right in addition to the upward direction in FIG. 9. In FIG. 9, an angle Ax of the V is about 60 degrees.

In contrast, in the present embodiment, the growth direction of the vortex tube 80 is only upward in FIG. 7, so that the growth direction of the vortex tube 80 is more limited than in a comparative example. As a result, an energy cascade is less likely to occur in the present embodiment than in the comparative example. An energy cascade refers to a process in which large vortices in a turbulent flow generate small vortices, and the energy of the vortices is converted into heat. Small vortices generated in the turbulent flow are converted to heat due to an operation of viscosity and disappear. For this reason, if the process in which large vortices generate small vortices is obstructed, an energy loss can be suppressed.

For example, a radius of the vortex tube 80 in the turbulent flow shrinks as it grows vertically. For example, the vortex tube 80 becomes longer and thinner vertically as it grows. For example, when a growth of the vortex tube 80 becomes saturated, a new vortex tube (not shown) that is smaller in scale than the vortex tube 80 whose growth has become saturated grows in a direction (horizontal direction) orthogonal to the growth direction of the vortex tube 80. This process of growing a new vortex tube is one cause of the energy cascade.

In the present embodiment, the first side wall surface 61 and the second side wall surface 62 extend perpendicularly from the bottom wall surface 51 in a cross-sectional view orthogonal to the extension direction Vt of the tube 21. For this reason, the first side wall surface 61 and the second side wall surface 62 can obstruct a phenomenon of a new vortex tube being generated in a direction orthogonal to the growth direction of the vortex tube 80. As a result, it is possible to obstruct the energy cascade.

### <Operation Effect>

As described above, the heat exchanger 20 of the present embodiment includes a tube 21 that has an inner surface 21A facing the internal passage 26 through which the exhaust gas discharged from the engine 2 can flow, and an outer surface 21B facing the external passage 27 through which cooling water for heat exchange with the exhaust gas can flow, and extends in the flow direction of the exhaust gas, and a riblet structure 50 that is provided on the inner surface 21A of the tube 21 and has a plurality of convex portions 60 extending in the extension direction Vt of the tube 21. The riblet structure 50 has a bottom wall surface 51 that is aligned with the inner surface 21A of the tube 21 at the bottom between two adjacent convex portions 60 among the plurality of convex portions 60.

According to this configuration, by having the bottom wall surface 51 that is aligned with the inner surface 21A of the tube 21, the vortex tube 80 grows in the vertical direction (upward in FIG. 7) intersecting with the bottom wall surface 51. For this reason, the growth direction of the vortex tube 80 is more limited than in the comparative example of FIG. 9. As a result, it is possible to obstruct the energy cascade and reduce a pressure loss of the internal passage 26. In addition, the riblet structure 50 of the inner surface 21A of the tube 21 increases a surface area of a portion facing the internal passage 26, thereby improving the heat exchange efficiency. Furthermore, there is no need to change (for example, enlarge) a size of the heat exchanger 20. Therefore, the pressure loss of the internal passage 26 through which the exhaust gas flows can be reduced and the heat exchange efficiency can be improved without changing the size.

In this embodiment, the riblet structure 50 has a first side wall surface 61 and a second side wall surface 62 that face each other in two convex portions 60. In a cross-sectional view orthogonal to the extension direction Vt of the tube 21, the bottom wall surface 51, the first side wall surface 61, and the second side wall surface 62 have shapes that are aligned with three sides of a rectangle.

According to this configuration, the growth direction of the vortex tube 80 is more limited than in the V-shape (comparative example) of FIG. 9. As a result, it is possible to efficiently obstruct the energy cascade. Therefore, the pressure loss of the internal passage 26 can be efficiently reduced.

In the present embodiment, in the cross-sectional view orthogonal to the extension direction Vt of the tube 21, the first side wall surface 61 and the second side wall surface 62 extend perpendicularly from the bottom wall surface 51.

According to this configuration, the vortex tube 80 does not grow in the lateral direction (the horizontal direction in FIG. 7). For this reason, the vortex tube 80 grows only in the vertical direction (only upward in FIG. 7). As a result, it is possible to efficiently obstruct the energy cascade. Therefore, the pressure loss of the internal passage 26 can be efficiently reduced.

In this embodiment, in a cross-sectional view orthogonal to the extension direction Vt of the tube 21, the riblet structure 50 further has the inclined wall surfaces 63 and 64 that extend obliquely from the ends of the first side wall surface 61 and the second side wall surface 62 opposite to the bottom wall surface 51.

According to this configuration, the surface area of the portion facing the internal passage 26 is further increased by the inclined wall surfaces 63 and 64 of the riblet structure 50. For this reason, it is possible to further improve the heat exchange efficiency.

The present embodiment further includes a fin 25 that is provided in the internal passage 26 and extends in the extension direction Vt of the tube 21. The riblet structure 50 is provided on the surface of the fin 25.

According to this configuration, the surface area of the portion facing the internal passage 26 is further increased by the riblet structure 50 on the surface of the fin 25. For this reason, it is possible to further improve the heat exchange efficiency.

In this embodiment, the riblet structure 50 is provided on the outer surface 21B of the tube 21.

According to this configuration, a surface area of a portion facing the external passage 27 is further increased by the riblet structure 50 of the outer surface 21B of the tube 21. For this reason, it is possible to further improve the heat exchange efficiency. In addition, a pressure loss of the external passage 27 through which the cooling water flows can be reduced.

In the present embodiment, the heat exchanger 20 is a heat exchanger 20 for the EGR cooler 3 that cools the EGR gas when a part of the exhaust gas is recirculated to the engine 2 as an EGR gas.

According to this configuration, in the heat exchanger 20 for the EGR cooler 3, the pressure loss of the internal passage 26 through which the exhaust gas flows can be reduced and the heat exchange efficiency can be improved without changing the size.

In the present embodiment, the minimum opening width w1 is 1 μm or more and 50 μm or less.

According to this configuration, it is possible to prevent a vortex layer having a diameter exceeding 50 μm from entering the opening 70 of the riblet structure 50 (a lower part of the opening 70 in FIG. 6). This can prevent the vortex tube 80 from wrapping the vortex layer and growing in the opening 70. As a result, it is possible to efficiently obstruct the energy cascade. Therefore, the pressure loss of the internal passage 26 can be efficiently reduced.

### First Modified Example

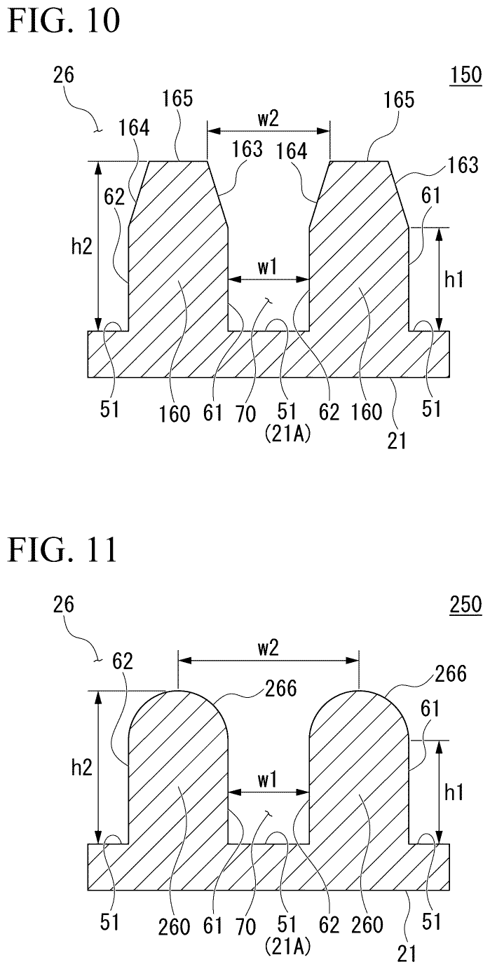

In the embodiment, an example (refer to FIG. 6) in which one convex portion 60 has a shape that combines a rectangle and a triangle in a cross-sectional view of the riblet structure 50 has been described. As shown in FIG. 10, a first modified example differs from the embodiment in that one convex portion 160 has a shape that combines a rectangle and a trapezoid. In the following description, the same components as those in the embodiment are denoted by the same reference numerals and the descriptions thereof will be omitted.

FIG. 10 is a cross-sectional view of the riblet structure 150 according to the first modified example of the embodiment. In the cross-sectional view of FIG. 10, an enlarged view of a part of a portion of the heat exchanger 20 where the riblet structure 150 is provided (for example, the portion on the inner surface 21A side of the tube 21) is shown.

In the cross-sectional view of FIG. 10, the riblet structure 150 further has an upper wall surface 165 extending in the horizontal direction from upper ends of the first inclined wall surface 163 and the second inclined wall surface 164. In the cross-sectional view of FIG. 10, the upper wall surface 165 extends parallel to the bottom wall surface 51 from ends of the first inclined wall surface 163 and the second inclined wall surface 164 opposite to the bottom wall surface 51.

In the cross-sectional view of FIG. 10, when one convex portion 160 is focused on, the upper wall surface 165, the first inclined wall surface 163, and the second inclined wall surface 164 have shapes that are aligned with three sides of a trapezoid. In the cross-sectional view of FIG. 10, one convex portion 160 has a shape that combines a rectangle and a trapezoid.

In the first modified example, in a cross-sectional view orthogonal to the extension direction Vt of the tube 21, the riblet structure 150 further has an upper wall surface 165 that extends parallel to the bottom wall surface 151 from the ends of the first inclined wall surface 163 and the second inclined wall surface 164 opposite to the bottom wall surface 51.

According to this configuration, the surface area of the portion facing the internal passage 26 is further increased by the upper wall surface 165 of the riblet structure 150. As a result, it is possible to further improve the heat exchange efficiency.

### Second Modified Example

As shown in FIG. 11, a second modified example differs from the embodiment in that one convex portion 260 has a shape that combines a rectangle and a semicircle. In the following description, the same components as those in the embodiment are denoted by the same reference numerals and the descriptions thereof will be omitted.

FIG. 11 is a cross-sectional view of a riblet structure 250 according to the second modified example of the embodiment. In the cross-sectional view of FIG. 11, an enlarged view of a part of a portion of the heat exchanger 20 where the riblet structure 250 is provided (for example, the portion on the inner surface 21A side of the tube 21) is shown.

In the cross-sectional view of FIG. 11, the riblet structure 250 further has a curved wall surface 266 that curves and extends from the upper ends of the first side wall surface 61 and the second side wall surface 62. In the cross-sectional view of FIG. 11, the curved wall surface 266 curves upward from ends of the first side wall surface 61 and the second side wall surface 62 opposite to the bottom wall surface 51. In the cross-sectional view of FIG. 11, when one convex portion 260 is focused on, it has a shape that combines a rectangle and a semicircle.

In the second modified example, in the cross-sectional view orthogonal to the extension direction Vt of the tube 21, the riblet structure 250 further has the curved wall surface 266 that curves and extends from the ends of the first side wall surface 61 and the second side wall surface 62 opposite to the bottom wall surface 51.

According to this configuration, the surface area of the portion facing the internal passage 26 is further increased by the curved wall surface 266 of the riblet structure 250. As a result, it is possible to further improve the heat exchange efficiency.

### Third Modified Example

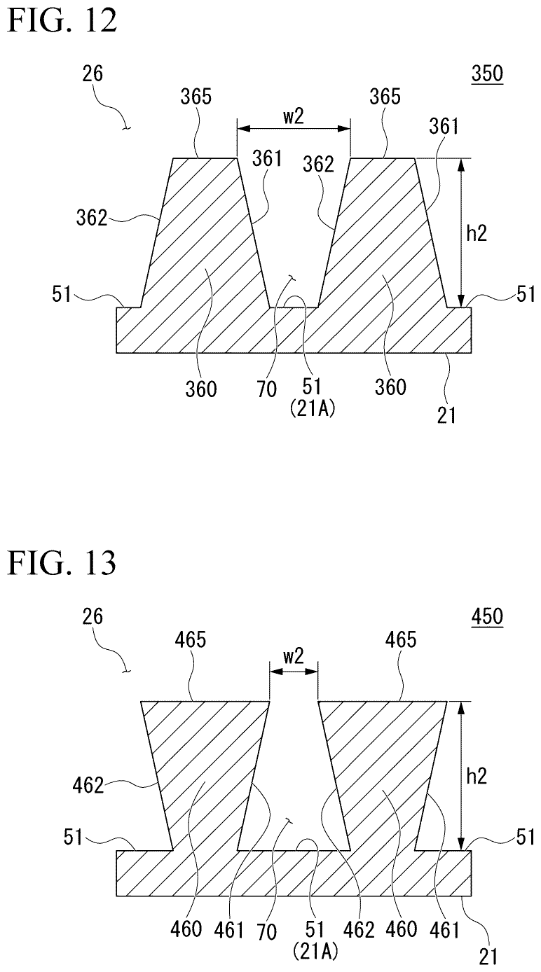

As shown in FIG. 12, a third modified example differs from the embodiment in that one convex portion 360 has a shape of a trapezoid. In the following description, the same components as those in the embodiment are denoted by the same reference numerals and the descriptions thereof will be omitted.

FIG. 12 is a cross-sectional view of a riblet structure 350 according to the third modified example of the embodiment. In the cross-sectional view of FIG. 12, an enlarged view of a part of a portion of the heat exchanger 20 where the riblet structure 350 is provided (for example, the portion on the inner surface 21A side of the tube 21) is shown.

In the cross-sectional view of FIG. 12, the riblet structure 350 further has an upper wall surface 365 extending in the horizontal direction from the upper ends of the first side wall surface 361 and the second side wall surface 362. In the cross-sectional view of FIG. 12, the upper wall surface 365 extends parallel to the bottom wall surface 51 from the ends of the first side wall surface 361 and the second side wall surface 362 opposite to the bottom wall surface 51. In the cross-sectional view of FIG. 12, the first side wall surface 361 and the second side wall surface 362 are inclined with respect to the bottom wall surface 51. In the cross-sectional view of FIG. 12, when one convex portion 360 is focused on, the side wall surfaces 361 and 362 gradually approach each other as they move upward from the bottom wall surface 51. In the cross-sectional view of FIG. 12, the bottom wall surface 51, the first side wall surface 361, and the second side wall surface 362 have shapes that are aligned with three sides of a trapezoid. In the cross-sectional view of FIG. 12, when one convex portion 60 is focused on, it has a shape of an isosceles trapezoid.

In the third modified example, in the cross-sectional view orthogonal to the extension direction Vt of the tube 21, the riblet structure 350 further has an upper wall surface 365 that extends in the horizontal direction from the upper ends of the first side wall surface 361 and the second side wall surface 362. In the cross-sectional view orthogonal to the extension direction Vt of the tube 21, the first side wall surface 361 and the second side wall surface 362 are inclined with respect to the bottom wall surface 51.

According to this configuration, the surface area of the portion facing the internal passage 26 is further increased by the upper wall surface 365 of the riblet structure 350 and the side wall surfaces 361 and 362 inclined with respect to the bottom wall surface 51. As a result, it is possible to further improve the heat exchange efficiency.

### Fourth Modified Example

As shown in FIG. 13, the fourth modified example differs from the embodiment in that one convex portion 460 has an inverted trapezoid shape. In the following description, the same components as those in the embodiment are denoted by the same reference numerals and the descriptions thereof will be omitted.

FIG. 13 is a cross-sectional view of the riblet structure 450 according to the fourth modified example of the embodiment. In the cross-sectional view of FIG. 13, an enlarged view of a part of a portion of the heat exchanger 20 where the riblet structure 450 is provided (for example, the portion on the inner surface 21A side of the tube 21) is shown.

In the cross-sectional view of FIG. 13, the riblet structure 450 further has an upper wall surface 465 extending in the horizontal direction from upper ends of the first side wall surface 461 and the second side wall surface 462. In the cross-sectional view of FIG. 13, the upper wall surface 465 extends parallel to the bottom wall surface 51 from the ends of the first side wall surface 461 and the second side wall surface 462 opposite to the bottom wall surface 51. In the cross-sectional view of FIG. 13, the first side wall surface 461 and the second side wall surface 462 are inclined with respect to the bottom wall surface 51. When one convex portion 460 is focused on in the cross-sectional view of FIG. 13, the side wall surfaces 461 and 462 gradually move away from each other as they move upward from the bottom wall surface 51. In the cross-sectional view of FIG. 13, the bottom wall surface 51, the first side wall surface 461, and the second side wall surface 462 have shapes that are aligned with three sides of a trapezoid. When one convex portion 460 is focused on in the cross-sectional view of FIG. 13, it has an upside-down shape of an isosceles trapezoid.

In the fourth modified example, in the cross-sectional view orthogonal to the extension direction Vt of the tube 21, the riblet structure 450 further has an upper wall surface 465 that extends in the horizontal direction from the upper ends of the first side wall surface 461 and the second side wall surface 462. In the cross-sectional view orthogonal to the extension direction Vt of the tube 21, the first side wall surface 461 and the second side wall surface 462 are inclined with respect to the bottom wall surface 51.

According to this configuration, the surface area of the portion facing the internal passage 26 is further increased by the upper wall surface 465 of the riblet structure 450 and the side wall surfaces 461 and 462 inclined with respect to the bottom wall surface 51. As a result, it is possible to further improve the heat exchange efficiency.

### OTHER EMBODIMENTS

In the embodiment described above, an example in which the heat exchanger is provided in the internal passage and further includes a fin extending in the extension direction of the tube has been described, but the present is not limited to this. For example, the heat exchanger does not have to include a fin. For example, the heat exchanger may include a tube that has an inner surface facing the internal passage through which an exhaust gas discharged from the engine can flow and an outer surface facing the external passage through which cooling water for heat exchange with the exhaust gas can flow, and extends in the flow direction of the exhaust gas, and a riblet structure that is provided on the inner surface of the tube and has a plurality of convex portions extending in the extension direction of the tube. For example, a configuration mode of the heat exchanger can be changed according to the design specifications.

In the embodiment described above, an example in which the riblet structure is provided on the surface of the fin has been described, but the present invention is not limited to the above. For example, the riblet structure may be provided on one surface of the fin (for example, either the upper surface or the lower surface). For example, the riblet structure does not have to be provided on the surface of the fin. For example, the riblet structure may be provided on the inner surface of the tube. For example, an installation mode of the riblet structure can be changed according to the design specifications.

In the embodiment described above, an example in which the riblet structure is provided on the outer surface of the tube has been described, but the present invention is not limited to this. For example, the riblet structure does not have to be provided on the outer surface of the tube. For example, the riblet structure may be provided on the inner surface of the tube. For example, the installation mode of the riblet structure can be changed according to the design specifications.

In the embodiment described above, an example in which the tube has a flat shape has been described, but the present invention is not limited to this. For example, the tube may have a circular (annular) cross section. For example, the shape of the tube can be changed according to the design specifications.

Although the embodiments of the present invention have been described above, the present invention is not limited to these, and additions, omissions, substitutions, and other modifications can be made within a range not departing from the gist of the present invention, and the embodiments described above can also be combined as appropriate.

### (Appendix 1)

A heat exchanger includes a tube that has an inner surface facing an internal passage through which an exhaust gas discharged from an engine is able to flow and an outer surface facing an external passage through which cooling water for heat exchange with the exhaust gas is able to flow, and extend in a flow direction of the exhaust gas, and a riblet structure that is provided on the inner surface of the tube and has a plurality of convex portions extending in an extension direction of the tube, in which the riblet structure has a bottom wall surface that is aligned with the inner surface of the tube at a bottom between two adjacent convex portions among the plurality of convex portions.

### (Appendix 2)

The heat exchanger according to Appendix 1, in which the riblet structure has a first side wall surface and a second side wall surface that face each other in the two convex portions, and the bottom wall surface, the first side wall surface, and the second side wall surface have shapes that are aligned with three sides of a rectangle in a cross-sectional view orthogonal to the extension direction of the tube.

### (Appendix 3)

The heat exchanger according to Appendix 2, in which the first side wall surface and the second side wall surface extend perpendicularly from the bottom wall surface in a cross-sectional view orthogonal to the extension direction of the tube.

### (Appendix 4)

The heat exchanger according to Appendix 2 or 3, in which the riblet structure further has an inclined wall surface that extends obliquely from ends of the first side wall surface and the second side wall surface opposite to the bottom wall surface in a cross-sectional view orthogonal to the extension direction of the tube.

### (Appendix 5)

The heat exchanger according to one of Appendix 1 to Appendix 4 further includes a fin that is provided in the internal passage and extends in the extension direction of the tube, in which the riblet structure is provided on a surface of the fin.

### (Appendix 6)

The heat exchanger according to one of Appendix 1 to Appendix 5, in which the riblet structure is provided on the outer surface of the tube.

### (Appendix 7)

The heat exchanger according to one of Appendix 1 to Appendix 6, in which, when a part of the exhaust gas is recirculated to the engine as an EGR gas, the heat exchanger is a heat exchanger for an EGR cooler that cools the EGR gas.

### BRIEF DESCRIPTION OF THE REFERENCE SYMBOLS

2 Engine
3 EGR cooler
20 Heat exchanger
21 Tube
21A Inner surface
21B Outer surface
25 Fin
26 Internal passage
27 Cooling water passage (External passage)
50 Riblet structure
51 Bottom wall surface
60 Convex portion
61 First side wall surface
62 Second side wall surface
63 First inclined wall surface (Inclined wall surface)
64 Second inclined wall surface (Inclined wall surface)
Vt Extension direction of tube

1. A heat exchanger comprising:
a tube that has an inner surface facing an internal passage through which an exhaust gas discharged from an engine is able to flow and an outer surface facing an external passage through which cooling water for heat exchange with the exhaust gas is able to flow, and extends in a flow direction of the exhaust gas; and
a riblet structure that is provided on the inner surface of the tube and has a plurality of convex portions extending in an extension direction of the tube,
wherein the riblet structure has a bottom wall surface that is aligned with the inner surface of the tube at a bottom between two adjacent convex portions among the plurality of convex portions.

2. The heat exchanger according to claim 1,
wherein the riblet structure has a first side wall surface and a second side wall surface that face each other in the two convex portions, and
the bottom wall surface, the first side wall surface, and the second side wall surface have shapes that are aligned with three sides of a rectangle in a cross-sectional view orthogonal to the extension direction of the tube.

3. The heat exchanger according to claim 2,
wherein the first side wall surface and the second side wall surface extend perpendicularly from the bottom wall surface in a cross-sectional view orthogonal to the extension direction of the tube.

4. The heat exchanger according to claim 2,
wherein the riblet structure further has an inclined wall surface that extends obliquely from ends of the first side wall surface and the second side wall surface opposite to the bottom wall surface in a cross-sectional view orthogonal to the extension direction of the tube.

5. The heat exchanger according to claim 1, further comprising:
a fin that is provided in the internal passage and extends in the extension direction of the tube,
wherein the riblet structure is provided on a surface of the fin.

6. The heat exchanger according to claim 1,
wherein the riblet structure is provided on the outer surface of the tube.

7. The heat exchanger according to claim 1,
wherein, when a part of the exhaust gas is recirculated to the engine as an EGR gas, the heat exchanger is a heat exchanger for an EGR cooler that cools the EGR gas.

8. The heat exchanger according to claim 2,
wherein the riblet structure further has an inclined wall surface that extends obliquely from ends of the first side wall surface and the second side wall surface opposite to the bottom wall surface in a cross-sectional view orthogonal to the extension direction of the tube.

9. The heat exchanger according to claim 2, further comprising:
a fin that is provided in the internal passage and extends in the extension direction of the tube,
wherein the riblet structure is provided on a surface of the fin.

10. The heat exchanger according to claim 2,
wherein the riblet structure is provided on the outer surface of the tube.

11. The heat exchanger according to claim 2,
wherein, when a part of the exhaust gas is recirculated to the engine as an EGR gas, the heat exchanger is a heat exchanger for an EGR cooler that cools the EGR gas.
